(19) United States
(12) Patent Application Publication
(10) Pub. No.: US 2011/0094816 A1
(43) Pub. Date: Apr. 28, 2011

(54) ALL TERRAIN VEHICLE

(75) Inventors: Yasuhiro SUZUKI, Shizuoka (JP); Takehiko ARAI, Shizuoka (JP); Kouji YAMAMOTO, Shizuoka (JP)

(73) Assignee: YAMAHA HATSUDOKI KABUSHIKI KAISHA, Iwata-shi (JP)

(21) Appl. No.: 12/604,417

(22) Filed: Oct. 23, 2009

(51) Int. Cl. B60K 5/02; B60K 5/00; B60K 17/354

(52) U.S. Cl. 180/291

(57) ABSTRACT

An all terrain vehicle includes a pair of right and left front wheels, at least a pair of right and left rear wheels, a vehicle body frame, a pair of right and left first roof supports, a pair of right and left second roof supports, a pair of right and left roof members, a seat, a front panel, an engine unit, a pair of right and left head light units and a front carry bar. The vehicle body frame supports the pair of front wheels and the pair of rear wheels. The right and left first roof supports are provided at transversely lateral sides of the vehicle body frame. The right and left second roof supports are also provided at the transversely lateral sides of the vehicle body frame. The right/left roof member connects an upper portion of the right/left first roof support and an upper portion of the right/left second roof support. The right/left head light unit overlaps with a right/left hub of the right/left front wheel in a longitudinal direction of the vehicle. The front carry bar is disposed forward of the vehicle body frame. The front carry bar includes a pair of right and left resin covers. The resin covers at least cover below the front portions of the right and left head light units, respectively.

### BACKGROUND OF THE INVENTION

1. Field of the Invention

The present invention relates to an all terrain vehicle, especially to an all terrain vehicle including a front carry bar provided in a front section of a vehicle body.

2. Description of the Related Art

US Patent Publication No. 2006/0270503 A1 discloses an example of the conventional all terrain vehicles. The vehicle is provided with a cabin, functioning as a space for carrying a driver and a passenger. The cabin is disposed between front wheels and rear wheels in a longitudinal direction of the vehicle. Furthermore, a vehicle body frame (e.g., a front fender) is longitudinally disposed forward of the cabin whereas a cargo area is longitudinally disposed rearward of the cabin.

Requests have been made for compactly forming the vehicle of this type. Especially, requests have been made for compactly forming the vehicle in the longitudinal direction. To achieve openness in the cabin, however, size reduction of the cabin space should be avoided.

It is therefore plausible to propose size reduction of a space positioned forward of the cabin, i.e., reduction of the longitudinal length of a space positioned forward of a front panel, for achieving reduction of the longitudinal length of the entire vehicle.

In general, front suspensions and a front gear case are disposed in the space positioned forward of the front panel. Accordingly, the vehicle body frame (e.g., a front fender) is inevitably extended forward for supporting the mechanisms. Consequently, an appropriate arrangement design is required for head light units and the front wheels, which are to be disposed in the front section of the vehicle, in order to compactly form the front section of the vehicle while the vehicle body frame is extended forward to a minimum-necessary extent.

In response to this, an arrangement of longitudinally overlapping the head light units and the hubs of the front wheels may be proposed for compactly forming the front section of the vehicle.

When this arrangement is adopted for such a vehicle, however, the head light units are positioned above the front wheels. Accordingly, the arrangement has a drawback in that soil and water (e.g., mud), splashed by rotation of the front wheels, easily contacts and attaches to the head light units.

### SUMMARY OF THE INVENTION

In view of the above, preferred embodiments of the present invention provide a compact vehicle that prevents contact with and attachment of soil and water (e.g., mud), splashed by rotation of the front wheels, to the head light.

A vehicle of this type is provided with a front carry bar that is used to lift up the vehicle. The front carry bar is disposed in the front section of the vehicle. The inventors of the present application discovered that a cover, attached with the use of the front carry bar, could inhibit contact with and attachment of soil and water (e.g., mud) to the head light units.

An all terrain vehicle according to a preferred embodiment the present invention includes a pair of right and left front wheels, at least a pair of right and left rear wheels, a vehicle body frame, a pair of right and left first roof supports, a pair of right and left second roof supports, a pair of right and left roof members, a seat, a front panel, an engine unit, a pair of right and left head light units and a front carry bar. The vehicle body frame supports the pair of front wheels and the pair of rear wheels. The first roof supports are disposed at lateral sides of the vehicle body frame in a transverse direction of the vehicle. Each of the first roof supports includes a pipe member extending in a substantially vertical direction of the vehicle. The second roof supports are also disposed in the transversely lateral sides of the vehicle body frame. The second roof supports are disposed rearward of the first roof supports in a longitudinal direction of the vehicle. Each of the second roof supports includes a pipe member extending in the substantially vertical direction of the vehicle. The right roof member connects an upper portion of the right first roof support and an upper portion of the right second roof support. On the other hand, the left roof member connects an upper portion of the left first roof support and an upper portion of the left second roof support. The seat is positioned forward of the rear end of the second roof supports in a transverse side view. The front panel sections a cabin for accommodating a driver and a front space of a front section of the vehicle. The cabin includes the seat therein. The front space is positioned longitudinally forward of the cabin. The engine unit is disposed below or longitudinally rearward of the seat. The engine unit is supported by the vehicle body frame. The head light units longitudinally overlap with a pair of right and left hubs of the right and left front wheels, respectively. The front carry bar is disposed longitudinally forward of the vehicle body frame. The front carry bar includes a resin cover arranged to at least cover areas below front portions of the right and left head light units, respectively.

According to a preferred embodiment of the present invention, the resin covers are attached to the vehicle body with the use of the front carry bar attached in general to a vehicle of this type. Therefore, even when the front section of the vehicle is compactly disposed for longitudinally overlapping the head light units and the hubs of the front wheels, the resin covers are capable of inhibiting contact with and attachment of soil and water (e.g., mud), splashed by rotation of the front wheels, to the head light units.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1A is a side view of an all terrain vehicle according to a preferred embodiment of the present invention.

FIG. 1B is an enlarged view of a portion of the all terrain vehicle illustrated in FIG. 1A.

FIG. 2 is a perspective view of the entire all terrain vehicle.

FIG. 3 is a perspective view of an entire vehicle body frame of the all terrain vehicle and a portion of mechanisms supported by the vehicle body frame.

FIG. 4 is a perspective view of an entire front panel and its periphery.

FIG. 5 is a diagram of the front panel seen from within the cabin.

FIG. 6 is an exploded view of a front section of the all terrain vehicle while a cover is removed from the front section.

FIG. 7 is a detailed view of the front cover.

FIG. 8 is a detailed view of an attachment condition of a head light unit.

FIG. 9 is a detailed view of a front carry bar.

FIG. 10 is a front view of the vehicle.

### DETAILED DESCRIPTION OF THE PREFERRED EMBODIMENTS

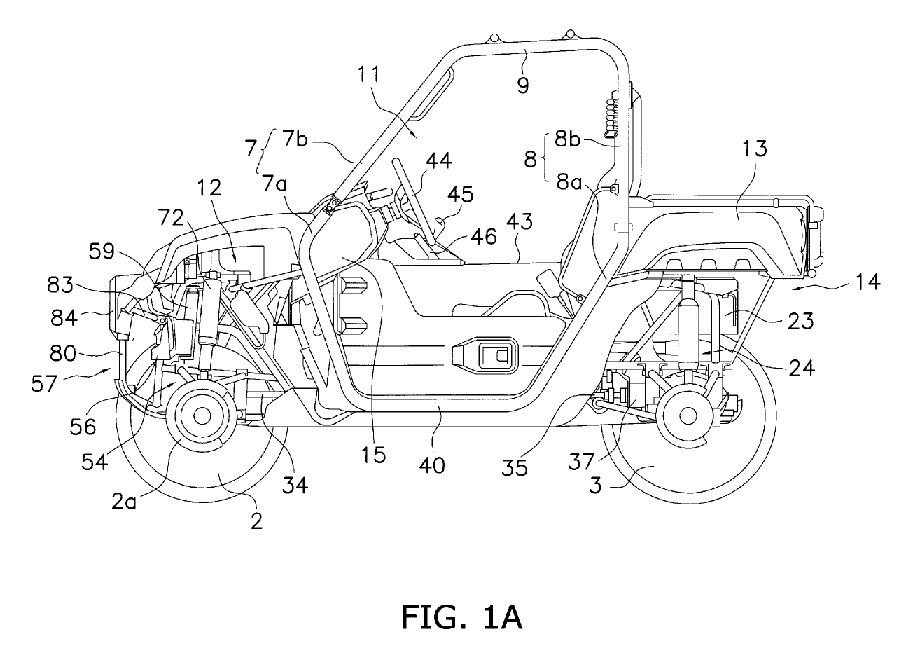

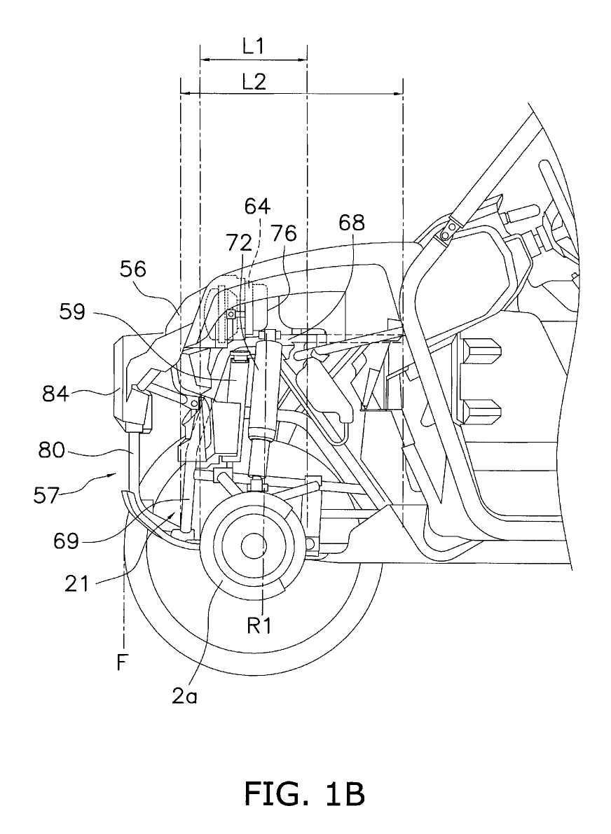

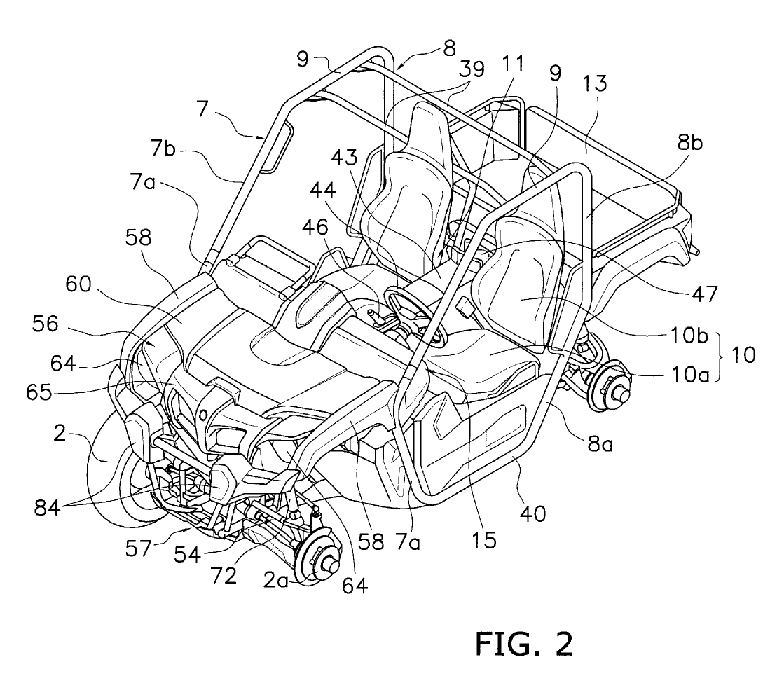

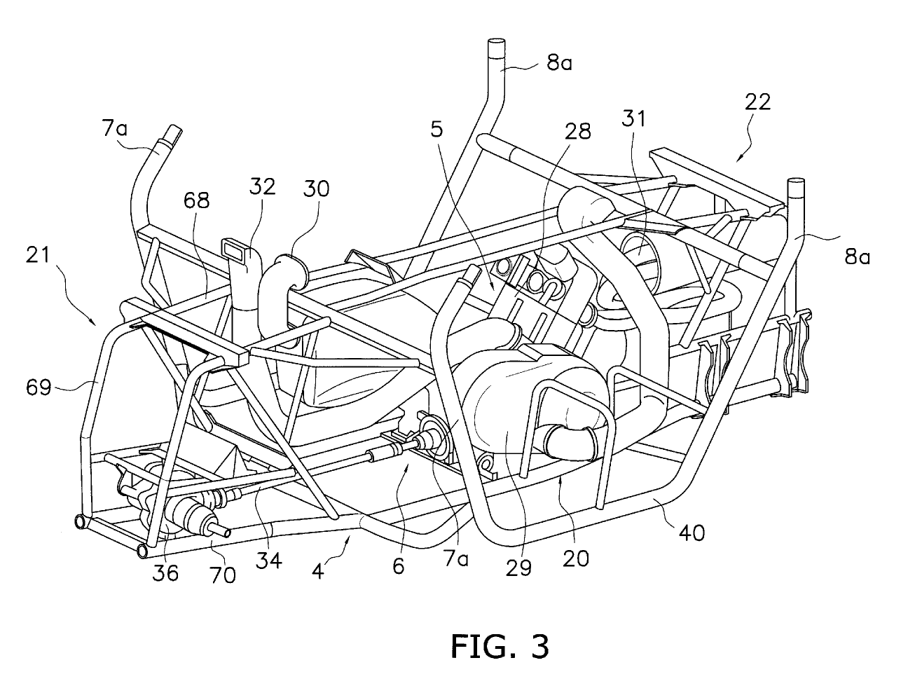

FIG. 1A is a side view of an all terrain vehicle according to a preferred embodiment of the present invention. FIG. 1B is an enlarged view of a portion of the all terrain vehicle of FIG. 1A. FIG. 2 is a perspective view of the entire all terrain vehicle. FIG. 3 is a perspective view of a vehicle body frame and main members supported thereby, removed from the all terrain vehicle. Note that FIGS. 1A and 1B illustrate a condition of the all terrain vehicle in which left-front and left-rear wheels are removed. FIG. 2 also illustrates a condition of the all terrain vehicle in which the left-front and left-rear wheels are removed. FIG. 3 illustrates a condition of the vehicle body frame and main members supported thereby in which upper portions of roof supports are removed. Excluding special occasions, directional terms “front,” “rear,” “right” and “left” and their related directional terms, used in the present specification, indicate directions seen by a driver riding on the vehicle.

The all terrain vehicle, illustrated in FIGS. 1A to 3, includes a pair of right and left front wheels 2, a pair of right and left rear wheels 3, a vehicle body frame 4, an engine unit 5, a power transmission mechanism 6, a pair of first roof supports 7, a pair of second roof supports 8, and a pair of roof members 9. The vehicle body frame 4 supports the front wheels 2 and the rear wheels 3. The power transmission mechanism 6 is configured to transmit power of the engine unit 5 to the front wheels 2 and the rear wheels 3. The first roof supports 7 and the second roof supports 8 are provided at transversely lateral sides of a longitudinally center portion of the vehicle body frame 4, respectively. Furthermore, the all terrain vehicle includes a cabin 11, a front space 12 and a rear space 14. The cabin 11 accommodates the seats 10. The cabin 11 thus functions as a space for carrying a driver and/or a passenger. The front space 12 is a front section of the vehicle disposed forward of the cabin 11. The rear space 14 is a rear section of the vehicle that a cargo 13 is disposed thereon. Additionally, a front panel 15 is provided between the cabin 11 and the front space 12. The cabin 11 and the front space 12 are thus sectioned by the front panel 15.

The vehicle body frame 4 mainly includes a center frame unit 20, a front frame unit 21 and a rear frame unit 22. The center frame unit 20 defines a bottom portion of the cabin 11. The front frame unit 21 is disposed in the front space 12 positioned forward of the center frame unit 20. The front frame unit 21 thus defines a front section of the vehicle. Additionally, the rear frame unit 22 is disposed in a rear space 14 positioned rearward of the center frame unit 20. The rear frame unit 22 thus defines a rear section of the vehicle.

The center frame unit 20 includes a plurality of pipe members. The center frame unit 20 supports the engine unit 5 through engine brackets (not illustrated in the figure).

Similarly to the center frame unit 20, each of the front frame unit 21 and the rear frame unit 22 includes a plurality of pipe members. The rear frame unit 22 supports a variety of components, including e.g., an exhaust duct 23 and a pair of right and left rear suspensions 24. The front frame unit 21 and its related components will be hereinafter explained in detail.

The engine unit 5 occupies an area extending from transversely below the seats 10 to rearward of the seat units 10. As described above, the engine unit 5 is supported by the center frame unit 20 through the engine brackets. The engine unit 5 includes an engine body 28 and a V-belt type continuously variable transmission (CVT) 29. The CVT 29 is disposed leftward of the engine body 28. Note that an intake-related mechanism 30 and an exhaust-related mechanism 31 are connected to the engine body 28. The intake-related mechanism 30 (e.g., an air cleaner) is disposed in the front section of the vehicle whereas the exhaust-related mechanism 31 is disposed in the rear section of the vehicle. A cooling duct 32 is connected to the CVT 29 for mainly cooling a belt. The cooling duct 32 is disposed rearward of the front space 12. In other words, the cooling duct 32 is disposed in the portion positioned forward of the cabin 11.

The power transmission mechanism 6 includes a front drive shaft 34, a rear drive shaft 35, a front gear case 36 and a rear gear case 37. The front drive shaft 34 and the rear drive shaft 35 are connected to the output side of the CVT 29. The front gear case 36 is disposed among the tip of the front drive shaft 34 and the front wheels 2 whereas the rear gear case 37 is disposed among the tip of the rear drive shaft 35 and the rear wheels 3.

The pair of right and left first roof supports 7, the pair of right and left second roof supports 8 and the pair of right and left roof members 9 define a pair of right and left lateral frames of the cabin 11.

The first roof supports 7 define the front ends of the pair of right and left lateral sides of the cabin 11. Each of the first roof supports 7 includes a pipe member extending in the substantially vertical direction. Each of the first roof supports 7 is divided into a lower support 7a and an upper support 7b. The lower support 7a and the upper support 7b are coupled preferably by a single or plurality of bolts, for example. The lower support 7a slants forward from its lower end to its upper end (i.e., a coupling portion with the upper support 7b). On the other hand, the upper support 7b slants rearward from its lower end (i.e., a coupling portion with the lower support 7a) to its upper end.

The second roof supports 8 define the rear ends of the pair of right and left lateral sides of the cabin 11. Each of the second roof supports 8 includes a pipe member extending in the substantially vertical direction. Similarly to the first roof supports 7, each of the second roof supports 8 is divided into a lower support 8a and an upper support 8b. The lower support 8a and the upper support 8b are coupled preferably by a single or plurality of bolts, for example. The lower support 8a slants rearward from its lower end to its upper end (i.e., a coupling portion with the upper support 8b). On the other hand, the upper support 8b is disposed approximately-upright.

Note each of the first and second roof supports 7 and 8 is divided into lower and upper supports at its approximately vertical center portion. The coupling portions between the lower and upper supports are positioned at approximately the same height as the upper end of the front panel 15.

Each of the roof members 9 includes a pipe member extending in the longitudinal direction. The right/left roof member 9 is provided between the upper end of the right/left first roof support 7 and the upper end of the right/left second roof support 8. The roof members 9 are approximately horizontally disposed. Furthermore, two coupling members 39 are disposed between the pair of right and left roof members 9. The roof members 9 are coupled by the coupling members 39.

The right and left lateral frames of the cabin 11 further include a pair of right and left lower members 40 in addition to the first roof supports 7, the second roof supports 8 and the roof members 9. Each of the lower members 40 includes a pipe member. The right/left lower member 40 is disposed between the lower end of the right/left first roof support 7 and the lower end of the right/left second roof support 8. The lower members 40 are approximately horizontally disposed. The lower members 40 are thus opposed to the roof members 9 in the substantially vertical direction.

In the present preferred embodiment, the right/left upper support 7b of the right/left first roof support 7, the right/left upper support 8b of the right/left second roof support 8 and the right/left roof member 9 are preferably formed by bending a piece of pipe member, for example. Similarly, the right/left lower support 7a of the right/left first roof support 7, the right/left lower support 8a of the right/left second roof support 8 and the right/left lower member 40 are preferably formed by bending a piece of member, for example.

As seen in FIGS. 1A, 2 and 4, the cabin 11 is provided with the front panel 15, a bottom floor panel 42 and a center console 43. The center console 43 is disposed between the right and left seats 10. The cabin 11 is defined as a space enclosed by the floor panel 42, the front panel 15, and a portion of the pair of right and left lateral frames (including the first and second roof supports 7 and 8 and the roof members 9) disposed above the front panel 15.

A steering mechanism 44 is disposed in front of the left seat 10 within the cabin 11. The seats 10 are disposed forward of the rear ends of the second roof supports 8 within the cabin 11. More specifically, each of the right and left seats 10 includes a seating surface 10a and a back support 10b. The back support 10b supports the back of a driver/passenger. The back supports 10b of the seats 10 may overlap with the second roof supports 8 in the longitudinal direction. Alternatively, the back supports 10b may be partially positioned rearward of the second roof supports 8. However, the seating surfaces 10a of the seats 10 are always positioned forward of the rear ends of the second roof supports 8.

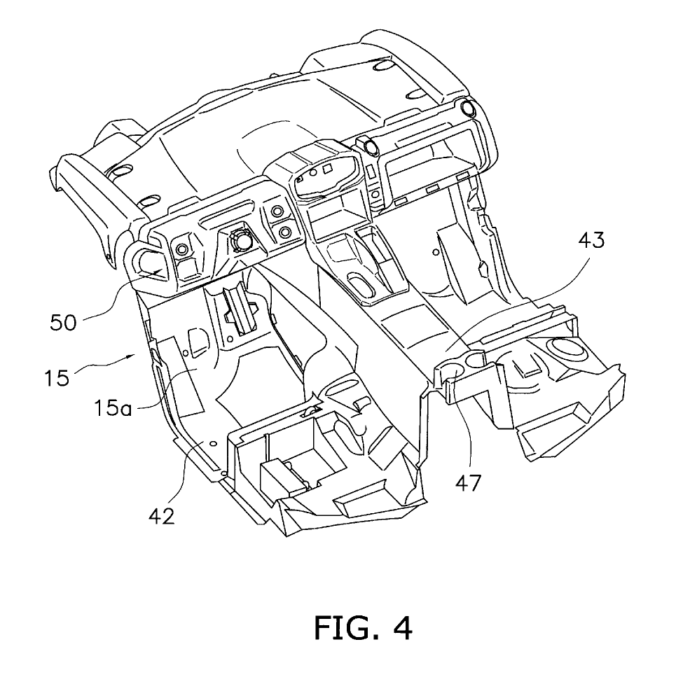

Furthermore, the center console 43 is disposed rearward of the front panel 15 while disposed in approximately the center portion of the vehicle in the transverse direction. The center console 43 extends rearward of the seats 10. The center console 43 includes left, right and upper walls. The center console 43 is formed in an inverse U-shape, and thereby includes an inner space. As illustrated in FIG. 1A, a speed change control lever 45 and a side brake control lever 46 are disposed in the front portion of the center console 43 whereas a bottle receiver 47 (see FIGS. 2 and 4) is disposed on the rear portion of the center console 43 for receiving a single or plurality of beverage bottles.

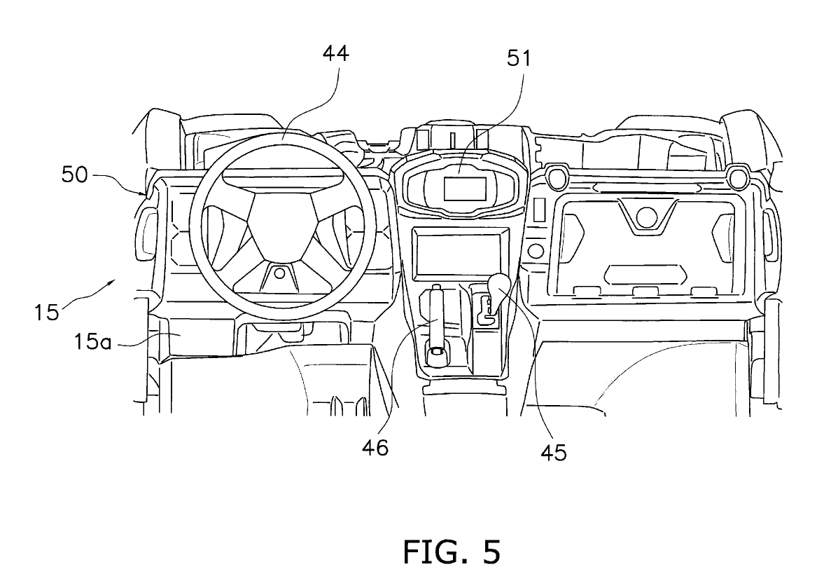

As described above, the front panel 15 is a member for sectioning the cabin 11 and the front space 12 positioned forward of the cabin 11. As illustrated in FIG. 4, the front panel 15 includes a vertical panel 15a and a dashboard 50. The vertical panel 15a extends continuously upward from the floor panel 42 of the cabin 11. The dashboard 50 is disposed on the upper end of the vertical panel 15a. As illustrated in FIG. 5, the steering mechanism 44 is attached to the left portion of the dashboard 50 whereas a meter unit 51, including a display (e.g., a speedometer), is disposed in the transversely center portion of the dashboard 50. Electric components are installed in the interior of the meter unit 51.

Next, structure of the front section of the vehicle, that is, structure of the front space 12 positioned forward of the front panel 15, will be hereinafter explained in detail.

As described above, the front frame unit 21 is disposed in the front space 12. As illustrated in FIGS. 1A to 3 and 6, the front frame unit 21 supports the front gear case 36, a pair of right and left front suspensions 54, a front box 55, a front cover 56, a front carry bar 57, a pair of right and left front fenders 58 and a radiator 59. Additionally, a hood 60 is disposed between the front fenders 58. Moreover, right and left head light units 64 and a front grill 65 are attached to the front cover 56.

As illustrated in FIG. 3, the front frame unit 21 is transversely symmetrically formed. The right-half/left-half portion of the front frame unit 21 includes a right/left upper frame 68, a right/left vertical frame 69 and a right/left lower frame 70. The right and left upper frames 68 are coupled to the upper front end of the center frame unit 20, and extend forward therefrom. The right/left vertical frame 69 is formed in a bent shape, and extends downward from the front end of the right/left upper frame 68. The right and left lower frames 70 are coupled to the lower front end of the center frame unit 20, and extend forward therefrom. The front end of the right/left lower frame 70 is connected to the lower end of the right/left vertical frame 69. Note the frame elements 68, 69 and 70 are coupled by separate coupling members in the substantially vertical, longitudinal and transverse directions. The structure enhances stiffness of the entire front frame unit 21.

The front gear case 36 is supported by the right and left lower frames 70. Additionally, the front gear case 36 is coupled to a pair of right and left hubs 2a of the right and left front wheels 2 by a pair of right and left shafts (see FIGS. 1A, 1B and 2).

Each of the right and left front suspensions 54 includes a shock absorber 72 and an arm member. The right and left shock absorbers 72 are arranged in an inverse V-shape in a front view of the vehicle. The lower end of the right/left shock absorber 72 is coupled to the right/left hub 2a of the right/left front wheel 2 through e.g., a knuckle arm whereas the upper end of the right/left shock absorber 72 is supported by the front portion of the right/left upper frame 68.

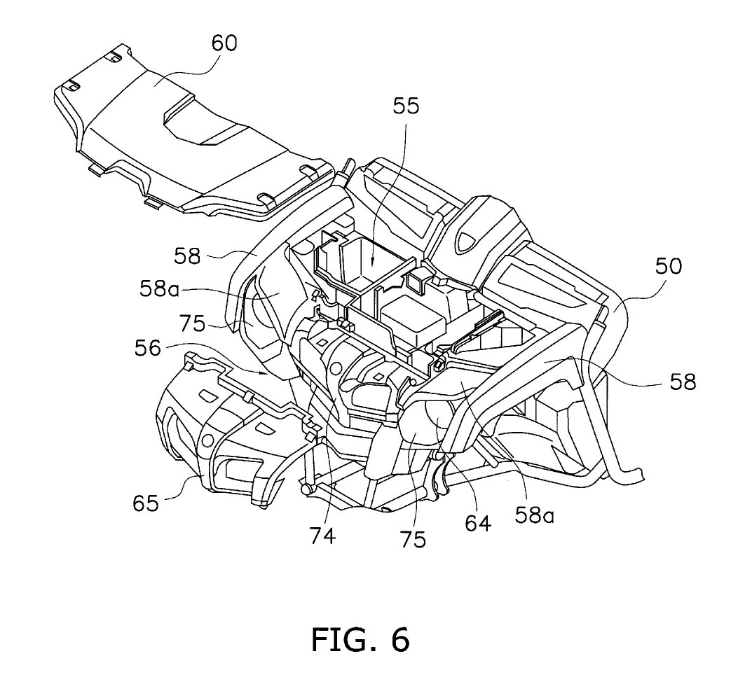

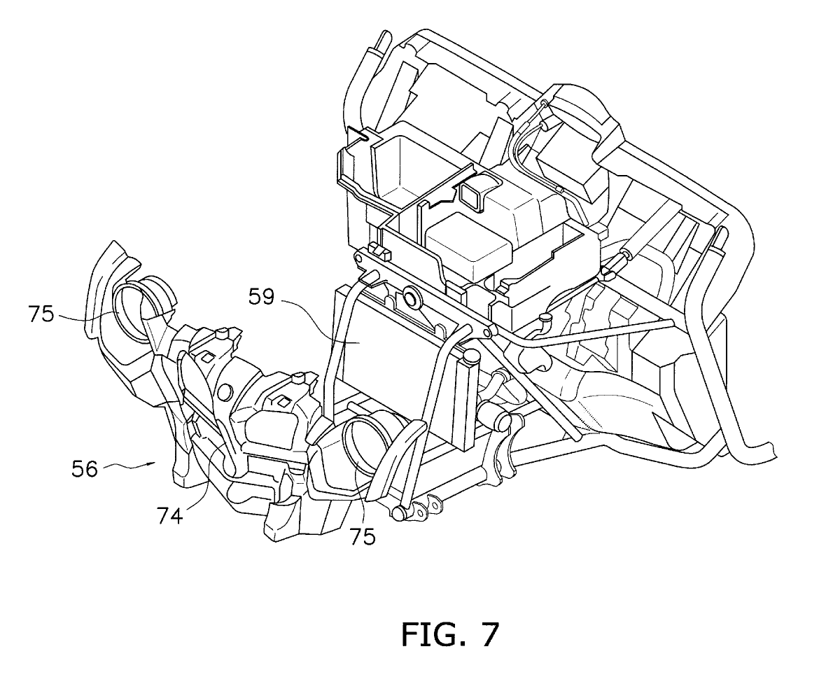

As illustrated in detail in FIGS. 6 and 7, the front cover 56 includes a center portion 74 and a pair of right and left head light covers 75. The center portion 74 is provided in approximately the center of the front cover 56 in the transverse direction, and includes an opening. The center portion 74 and the head light covers 75 preferably are integrally formed. The center portion 74 is disposed forward of the radiator 59 for covering it. The lower end of the center portion 74 extends further downward than the lower end of the radiator 59.

The front grill 65 covers the front of the center portion 74 of the front cover 56.

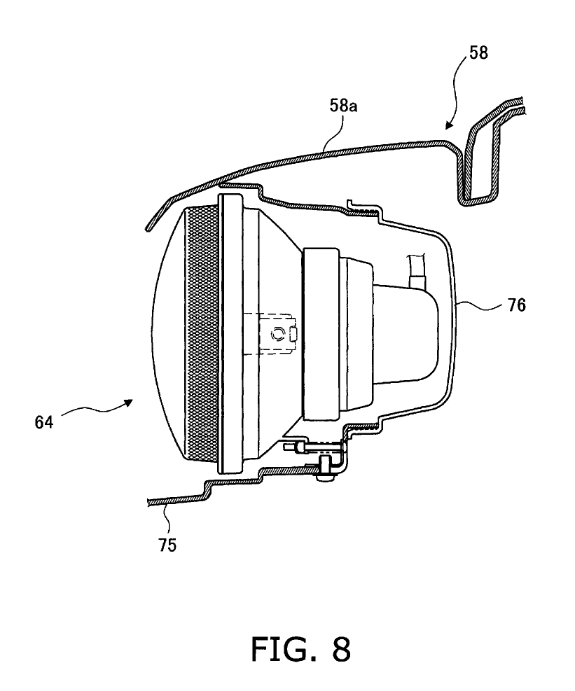

As illustrated in FIG. 8, each of the right and left head light units 64 includes a variety of components (e.g., a bulb, a reflection mirror and a lens) in its interior. The right/left head light cover 75 of the front cover 56 covers the surrounding of the right/left head light unit 64. Furthermore, a pair of right and left caps 76 are provided rearward of the head light units 64. The right/left cap 76 covers the back of the right/left head light cover 75.

The right/left head light unit 64 is attached to the right/left head light cover 75 preferably by a plurality of screws (not illustrated in the figure), for example. The positional relationship between the right/left head light unit 64 and the right/left head light cover 75 will be hereinafter explained.

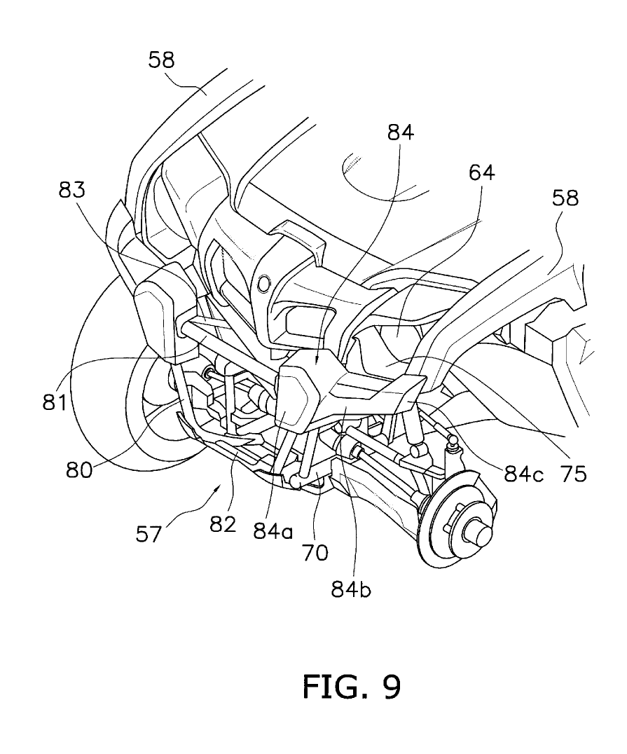

As illustrated in detail in FIG. 9, the front carry bar 57 preferably includes a pair of right and left L-shaped members 80, an upper coupling member 81, a lower coupling member 82 and a pair of lateral coupling members 83. The L-shaped members 80 extend in the substantially vertical direction. The upper coupling member 81 couples upper portions of the right and left L-shaped members 80 whereas the lower coupling member 82 couples lower portions of the right and left L-shaped members 80. The lower end of the right/left L-shaped member 80 is coupled to the right/left lower frame 70 of the front frame unit 21. Furthermore, the right/left lateral coupling member 83 couples the upper portion of the right/left L-shaped member 80 and the right/left vertical frame 69 of the front frame unit 21. Note that each of the members is preferably a pipe member.

A pair of right and left resin covers 84 are attached to the front carry bar 57. Specifically, the right/left resin cover 84 covers a coupling portion among the right/left L-shaped member 80, the upper coupling member 81 and the right/left lateral coupling member 83. The right and left resin covers 84 preferably are separately formed. The right/left resin cover 84 is fixed to the right/left L-shaped members 80 by a plurality of bolts, for example. The right and left resin covers 84 preferably are transversely symmetrically formed. Specifically, the right/left resin cover 84 preferably is formed in a cap shape, and opens only rearward. The right/left resin cover 84 includes a cover body 84a, an extension 84b and a protrusion 84c. The cover body 84a covers the aforementioned coupling portion among members 80, 81 and 83. The extension 84b extends transversely outward from the cover body 84a. The protrusion 84c is formed in the transversely outward tip of the extension 84b, and protrudes upward. Additionally, the extension 84b of the right/left resin cover 84 is disposed in approximately the same transverse position as the right/left head light unit 64. Furthermore, the upper surface of the extension 84b of the right/left resin cover 84 is positioned at approximately the same height as the surface of the right/left head light cover 75. The upper surface of the extension 84b of the right/left resin cover 84 and the surface of the right/left head light cover 75 continue in the longitudinal direction. Note that a clearance, having the same or substantially the same width as the radiator 59, is produced between the right and left resin covers 84. With the structure, cool air is supplied via the clearance to the rear-positioned radiator 59.

The right and left front fender 58 cover above the right and left front wheels 2, respectively. As illustrated in FIG. 6, an extension 58a is provided in the front portion of each front fender 58. The extensions 58a extend toward the transverse center of the vehicle. As illustrated in FIG. 8, the right/left extension 58a covers above the right/left head light cover 75. The front end of the right/left extension 58a extends forward of the front end of the upper portion of the right/left head light cover 75. The front end of the right/left extension 58a reaches approximately the same position as the front end of the lower portion of the right/left head light cover 75.

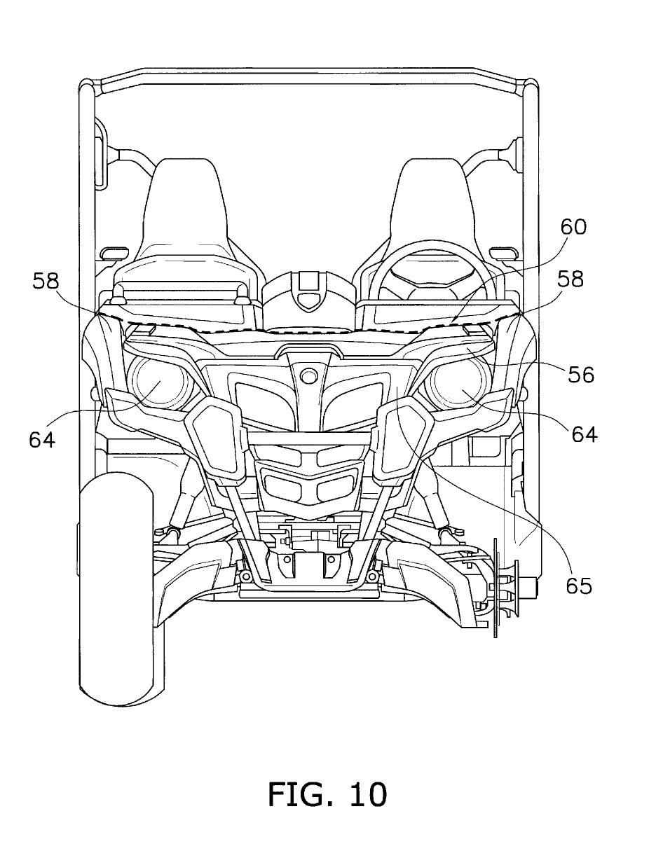

The hood 60 is disposed between the front fenders 58 for covering above the front box 55. The hood 60 is fixed to the front fenders 58. As is seen in the front view of the vehicle illustrated in FIG. 10, a thick dashed line indicates that the upper surface of the hood 60 is positioned lower than the front surfaces of the right and left front fenders 58. In other words, the upper surfaces of the right and left front fenders 58 (i.e., right and left lateral sides of the vehicle) are positioned higher than the upper surface of the hood 60 interposed therebetween. More specifically, transversely lateral portions of the hood 60 are positioned higher than a transversely center portion thereof. Additionally, the right and left front fenders 58 continue to the transversely right and left ends of the hood 60. A transversely outer portion of the right/left front fender 58 is basically positioned higher than a transversely inner portion thereof. Once reaching the highest position, however, the right/left front fender 58 slants downward at an acute angle in the front view of the vehicle.

Moreover, the upper ends of the right and left front fenders 58 are positioned higher than the head light units 64 in the side view of the vehicle. With the structure, it is possible to inhibit attachment of soil and water (e.g., mud), flying from transverse directions, to the head light units 64.

The front grill 65 is a member extending in the substantially vertical direction. The front grill 65 is attached to the front surface of the center portion 74 of the front cover 56. In other words, the front grill 65 is disposed rearward of the front carry bar 57. The front grill 65 and the center portion 74 of the front cover 56 block intrusion of soil and water (e.g., mud) into the interior of the vehicle from the front direction of the vehicle.

Regarding the aforementioned structure, positional relationships among members in the front section of the vehicle will be hereinafter particularly explained in detail.

First, as is shown in FIG. 1B, the pair of light and left head light units 64 overlap with the hubs 2a of the pair of right and left front wheels 2 in the longitudinal direction. In this case, the longitudinal overlapping range corresponds to a range L1. Specifically, as is shown in, e.g., FIG. 1B, the rear end R1 of the right/left head light unit 64 (more accurately, the rear end of the right/left cap 76) is arranged in approximately the same position as the center of the hub 2a of the right/left front wheel 2 in the longitudinal direction. With the structure, the longitudinal length of the front section of the vehicle is compactly formed. Furthermore, the right/left head light unit 64 longitudinally overlaps with a range L2. In this case, the right/left upper frame 68 and the right/left vertical frame 69 of the front frame unit 21 are disposed within the range L2. The lower end (i.e., foremost portion) of the right/left vertical frame 69 is positioned further forward than the front end of the right/left head light cover 75.

Next, the front carry bar 57 is arranged further forward than the front frame unit 21. The front carry bar 57 is entirely disposed forward of the head light units 64. Additionally, the front carry bar 57 is disposed further forward than the front ends of the hubs 2a. A front end F of the right/left front wheel 2 attached to the right/left hub 2a is longitudinally disposed in approximately the same position as the right/left L-shaped member 80 of the front carry bar 57. Therefore, the extension 84b of the right/left resin cover 84 attached to the front portion of the front carry bar 57 is disposed above the front end of the right/left front wheel 2 while disposed forwardly below the right/left head light unit 64. With the structure, the extensions 84b of the resin covers 84 are capable of inhibiting contact with and attachment of soil and water (e.g., mud), splashed by rotation of the front wheels 2, to the front surfaces of the head light units 64.

The front cover 56 is attached to the front frame unit 21. The front cover 56 is also positioned forward of the front frame unit 21 while positioned rearward of the front carry bar 57. The structure prevents intrusion of soil and water (e.g., mud), splashed by rotation of the front wheels 2, into the interior of the front space 12 that a variety of components (e.g., the front gear case 36) are disposed.

The right/left head light unit 64 preferably overlaps with the hub 2a of the right/left front wheel 2 in the longitudinal direction. With the structure, the front section of the vehicle is formed to have short longitudinal length. In other words, the all terrain vehicle is compactly formed.

Moreover, the head light units 64 overlap with the front portion of the front frame unit 21 in the longitudinal direction. With the structure, the all terrain vehicle is further compactly formed.

As described above, the right/left head light unit 64 and the hub 2a of the right/left front wheel 2 overlap in the longitudinal direction. In this case, soil and water (e.g., mud), splashed by rotation of the front wheels 2, easily travel to a vicinity of the head light units 64. According to the present preferred embodiment, however, the resin covers 84 are attached to the front carry bar 57 to cover at least the bottom of the front portions of the head light units 64. Accordingly, the resin covers 84 are capable of inhibiting contact with and attachment of soil and water (e.g., mud) to the head light units 64.

The right/left head light cover 75 is disposed rearward of the front end of the right/left front wheel 2 while disposed forward of the front surface (i.e., a lens plane) of the right/left head light unit 64. The head light covers 75, together with the resin covers 84, further prevent contact with and attachment of soil and water (e.g., mud), splashed by the front wheels 2, to the head light units 64.

Each of the first and second roof supports 7 and 8 is preferably separated into the upper and lower supports at approximately the same height as the upper end of the front panel 15. With the structure, when the upper supports 7b of the first roof supports 7, the upper supports 8b of the second roof supports 8 and the roof members 9 are removed from the vehicle and the handle 44 is then further removed, the remaining portion of the vehicle does not have any protrusions on its upper side. In this condition, the height of the entire vehicle will be approximately the half of the original height of the vehicle. Therefore, it is possible to reduce an accommodation space of a container for transporting the vehicle.

The aforementioned preferred embodiment exemplifies that each roof support preferably includes separately divided upper and lower supports. However, it is possible to apply the present invention to a type of vehicle provided with roof supports including only the upper supports described in the aforementioned preferred embodiment.

Structures of the vehicle body frame and the front carry bar may not be particularly limited to the aforementioned preferred embodiment. It is possible to similarly apply the present invention to any suitable front carry bars as long as a resin cover is attached thereto.

Shapes of the resin covers are not particularly limited to the aforementioned preferred embodiment. For example, the right and left resin covers may be continuously and integrally formed. In this case, it is desirable to form an aperture, a slit and the like in the center portion of the integrated resin cover for allowing cool air to reach the radiator positioned rearward of the center portion.

In the aforementioned preferred embodiment, the present invention is preferably applied to a two-seat vehicle. However, it is similarly possible to apply the present invention to a type of vehicle provided with a rear seat(s) in addition to the front seats.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. An all terrain vehicle comprising:
a pair of right and left front wheels;
at least a pair of right and left rear wheels;
a vehicle body frame arranged to support the front wheels and the rear wheels;
a pair of right and left first roof supports provided at lateral sides of the vehicle body frame in a transverse direction of the vehicle, respectively, each of the first roof supports including a pipe member extending in a substantially vertical direction of the vehicle;
a pair of right and left second roof supports provided at both lateral sides of the vehicle body frame in the transverse direction of the vehicle, respectively, the second roof supports being disposed rearward of the first roof supports in a longitudinal direction of the vehicle, each of the second roof supports including a pipe member extending in the substantially vertical direction of the vehicle;
a pair of right and left roof members arranged to connect an upper portion of the right first roof support and an upper portion of the right second roof support, the left roof member arranged to connect an upper portion of the left first roof support and an upper portion of the left second roof support;
a seat including a seating surface positioned forward of the rear end of the second roof supports in a transverse side view of the vehicle;
a front panel arranged to separate a cabin and a front space of a front section of the vehicle, the cabin including the seat therein, the front space being positioned longitudinally forward of the cabin;
an engine unit disposed below the seat or longitudinally rearward of the seat, the engine unit being supported by the vehicle body frame;
a pair of right and left head light units longitudinally overlapping with a pair of right and left hubs of the right and left front wheels, respectively; and
a front carry bar disposed longitudinally forward of the vehicle body frame, the front carry bar including a resin cover arranged to at least cover an area below front portions of the right and left head light units, respectively.

2. The all terrain vehicle according to claim 1, wherein the resin cover includes a left resin cover and aright resin cover, the left resin cover being arranged to cover below the front portion of the left head light unit, the right resin cover being arranged to cover below the front portion of the right head light unit, the right resin cover being separate from the left resin cover, and a clearance is provided between the left resin cover and the right resin cover so as to allow air to flow rearward.

3. The all terrain vehicle according to claim 1, further comprising vehicle body covers extending in the substantially vertical direction of the vehicle, the vehicle body covers being disposed longitudinally forward of the vehicle body frame, longitudinally rearward of the front carry bar, and longitudinally rearward of front ends of the front wheels.

4. The all terrain vehicle according to claim 1, further comprising a vehicle body cover including a surface longitudinally extending in front of the head light units.

5. The all terrain vehicle according to claim 3, wherein each of the pair of right and left resin covers has a cap shape opened rearward and includes a cover body positioned near a central portion of the vehicle, an extension extending transversely outward from the cover body and a protrusion provided on an outward tip of the extension, and the extensions of the pair of right and left resin covers are disposed in transversely the same positions as the right and left head light units, respectively.

6. The all terrain vehicle according to claim 5, further comprising a vehicle body cover including a surface longitudinally extending in front of the head light units, wherein upper surfaces of the extensions of the pair of right and left resin covers are positioned at approximately the same height as the surface of a head light cover for each of the right and left head light units, and the upper surfaces of the extensions and the upper surface of the head light covers are longitudinally continuous.

7. The all terrain vehicle according to claim 1, further comprising:
a pair of right and left suspensions arranged to support the right and left front wheels, respectively, each of the pair of right and left suspensions including a shock absorber; and
a front gear case arranged to transmit power of the engine unit to the front wheels; wherein
the vehicle body frame includes:
a pair of right and left upper frames longitudinally extending in front of the right and left first roof supports, respectively, the right and left upper frames including support portions arranged to support the shock absorbers, respectively; and
a pair of right and left lower frames positioned below the right and left upper frames, respectively, the right and left lower frames longitudinally extending in front of the right and left first roof supports, each of the right and left lower frames including a support portion arranged to support the front gear case; wherein
at least a portion of the right head light unit overlaps with the right upper frame and at least a portion of the left head light unit overlaps with the left upper frame.
